(19) United States
(12) Patent Application Publication
(10) Pub. No.: US 2004/0100236 A1
(43) Pub. Date: May 27, 2004

(54) Device for disconnecting and switching a load

(76) Inventor: Roland Mauser, Ludwigsburg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/311,281

(22) PCT Filed: Dec. 22, 2001
(86) PCT No.: PCT/EP01/15293

(30) Foreign Application Priority Data
Feb. 7, 2001 (DE) 101 05 457.2

(51) Int. Cl. G05F 1/40

(52) U.S. Cl. 323/282

(57) ABSTRACT

So that a fuse or a plug can be plugged in safely without generating an arc, the invention provides a device (1) for disconnecting and switching a load (2) with a control device (4) and with a switching element (14) which is arranged between a voltage supply (6) and the load (2) and is connected to the control device (4), an input (16) for the control device (4), provided between the voltage supply (6) and the switching element (14), being used to monitor at least one voltage limiting value, and the control device (4) deactivating the switching element (14) when the voltage drops below a first voltage limiting value.

The invention relates to a device for disconnecting and switching a load, particularly a load in a vehicle.

In order to supply voltage to various electrical loads, a vehicle comprises at least one vehicle-mounted electrical system and a control device for activating the respective load. The vehicle-mounted electrical system usually has a fuse which is triggered in the event of a short-circuit, for example in the cabling, or by a defect on the load. When a plug-type connection or the fuse is plugged in after the fault is remedied, an arc which in turn damages the respective contacts or fuses them, may occur when a load is switched on.

The invention is therefore based on the object of specifying a device for disconnecting and switching a load with which it is possible to plug in a fuse or other plugs without an arc being generated.

The object is achieved according to the invention by means of a device for disconnecting and switching a load with a control device and with a switching element which is arranged between a vehicle-mounted electrical system and the load and which is connected to the control device, as well as with an input, provided between the vehicle-mounted electrical system and the switching element, for the control device for monitoring at least one voltage limiting value, the control device deactivating the switching element when the voltage drops below a first voltage limiting value. This ensures that the element producing the load or the load is voltage-less by means of the deactivated switching element in the event of a fault in the vehicle-mounted electric system. Thus, the generation of an arc is reliably prevented when the fuse is used. The possible need to disconnect the terminals of the supply battery or to disconnect the vehicle-mounted electric system can be avoided. The use of a switching element provides a particularly simple device which can also be retrofitted into existing systems of a vehicle without a relatively large degree of expenditure. The control device or the controller preferably deactivates the switching element if the voltage from the vehicle-mounted electric system, which is tapped upstream of the switching element at the input, drops below the first voltage limiting value, in particular a value of less than 2V. Depending on the type and design of the voltage supply in a vehicle, for example 14V vehicle-mounted electric system, 42V vehicle-mounted electrical system or 60V battery, or mixed supply voltage, a correspondingly first voltage limiting value can be set in the control device. The first voltage limiting value is then compared with the voltage value present at the input by means of the control device. If the voltage value measured at the input is less than or equal to the first voltage limiting value, the switching element is deactivated by means of the control device.

The control device expediently activates the switching element when the voltage exceeds a second voltage delimiting value. A value which corresponds to the respective supply voltage is preferably predefined as the second voltage limiting value. For example, a value of greater than 30V is set as the second voltage limiting value in a 42V vehicle-mounted electric system. Depending on the design of the control device, the switching element is preferably activated after a predefinable time has expired or when a functional request is present. For example, after the fuse has been inserted and the voltage has exceeded the second voltage limiting value at the input of the control device, and when a restart of the vehicle occurs, the switching element is activated by reference to the position of the ignition lock. Alternatively, or additionally, the switching element is activated after the fuse has been inserted and the voltage has exceeded the second voltage limiting value at the input of the control device, and after a predetermined time has expired.

A semiconductor element or a relay is expediently provided as the switching element. For example, electronic analogue switches, such as diodes, bipolar transistors, field effect transistors, which permit rapid and precise switching, are used as the semiconductor element. In particular in the case of electrical motors which are usually regulated by means of pulse-width modulation, semiconductor switching elements are provided owing to the high switching frequencies.

Preferably, in the event of the controller and the load being jointly protected by means of a fuse element, the switching element can be switched with a delay when the voltage exceeds the second voltage limiting value. This ensures that, before the switching of the load, the control device is firstly supplied with voltage, as a result of which the criteria necessary to switch the load are checked by means of the control device. In other words: if a voltage which characterizes the safe operation of the voltage supply is present at the input of the control device, i.e. if the value is above the second voltage limiting value, the load is not switched, by actuating the switching element, until a predefined time has expired. This reliably avoids the generation of an arc.

The advantages obtained with the invention comprise, in particular, the fact that, owing to the continuous monitoring of the voltage from the vehicle-mounted electric system, undershooting of a critical voltage limiting value is determined and by reference to this switching element is deactivated by means of the control device until a normal voltage level of the vehicle-mounted electric system is detected. This ensures that a fault in the vehicle-mounted electric system which causes the critical voltage value and which leads to the fuse triggering can be remedied without generating an arc as a result of the plugging of plug-type connections or of the fuse. This is also ensured if the load continues to be switched on by disconnecting the branch between the vehicle-mounted electric system and the load by means of the switching element. Laborious disconnection of the terminals of the supply battery is thus also reliably avoided. Moreover, the control device automatically permits the switching element to be activated after the fault has been remedied.

Exemplary embodiments of the invention are explained in more detail with reference to a drawing, in which:

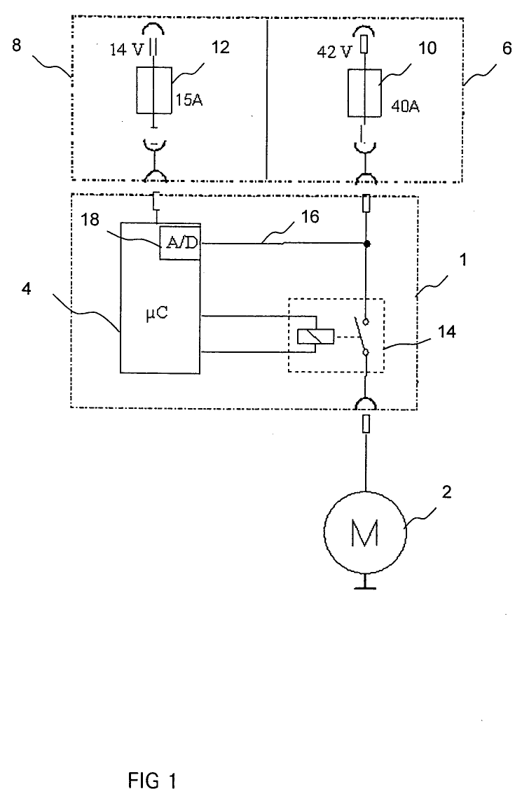

FIG. 1 is a schematic view of a device for disconnecting and switching a load with a control device and a switching element

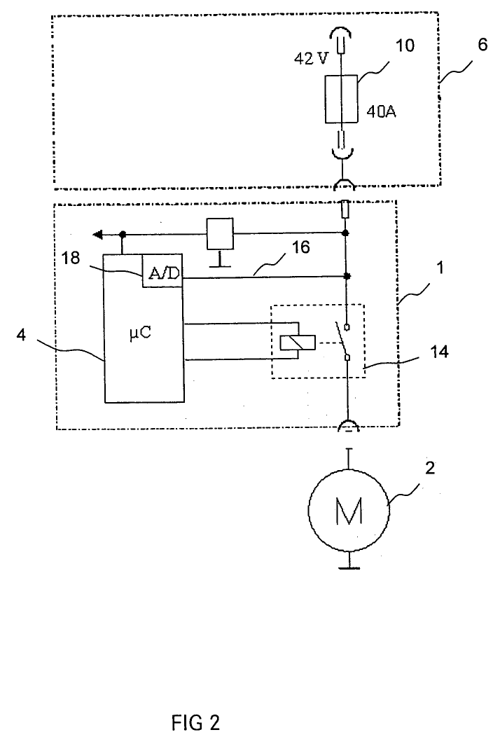

FIG. 2 is a schematic view of a device according to FIG. 1 with a common voltage supply for the load and the control device, and

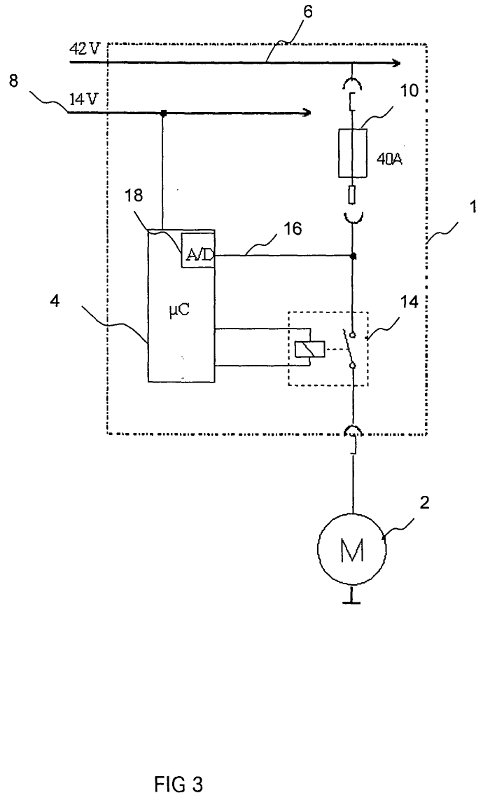

FIG. 3 is a schematic view of an alternative device according to FIG. 1.

Parts which correspond to one another are provided with the same reference symbols in all the figures.

FIG. 1 shows a device 1 for disconnecting and switching a load 2, for example a motor or a pump. The element producing the load or the load 2 is switched by means of a control device 4. The load 2 and the control device 4 are fed by two separate voltage supplies 6 and 8. In order to protect the load 2 and the control device 4, in each case an associated fuse element 10 or 12, respectively, is provided. For example a controller which is disconnected from the voltage supplies 6 and 8 and which is assigned to the respective load 2 to control it is used as the control device. The voltage supplies 6 and 8 may be embodied here as what are referred to as vehicle-mounted electrical systems with different voltages, for example a 14V vehicle-mounted electrical system for electric loads with low power, such as the control device, and an 42V vehicle-mounted electrical system for electric loads with a large power, for example an electric motor. Conventional fuses or other semiconductor element can be used as the fuse elements 10 and 12.

Moreover, a switching element 14 which is connected to the control device 4 is arranged in the branch for supplying the load 2 between the voltage supply 6 and the load 2. The switching element 14 can be embodied here as a relay or a semiconductor element, for example a transistor. In addition, an input 16 for the control device 4 is provided for monitoring at least one voltage limiting value in this branch between the voltage supply 6 and the switching element 14. The input 16 is fed to an analogue/digital converter 18 of the control device 4 for determining and monitoring the voltage present upstream of the switching element 14 and; if appropriate, for performing diagnostics.

In the event of a fault, for example a short-circuit in the voltage supply 6, which leads to triggering of the fuse element 10, the control device 4 deactivates the switching element 14 when the voltage drops below a first voltage limiting value G1 at the input 16. For this purpose, the voltage detected at the input 16 is compared with the first voltage limiting value G1, for example G1=2V, by means of the control device 4. If the voltage detected at the input 16 is less than 2V, the switching element 14 is deactivated, as a result of which the load 2 is disconnected from the voltage supply 6. Even when the load 2 is requested to be switched, it remains disconnected from the voltage supply 6 owing to the fault in the voltage supply 6. In other words, as long as a defective fuse element 10 is identified by means of the control device 4 by reference to the voltage at the input 16, the switching element 14 is not activated. For this purpose, the voltage detected at the input 16 is continuously monitored by means of the control device 4 to determine whether the voltage drops below the voltage limiting value G1. This permits the fuse element 10 to be plugged in without simultaneously applying the load 2 to the voltage supply 6. This reliably avoids the generation of an arc.

As a result of a new fuse element 10 being inserted, a voltage which is greater than the first voltage limiting value is applied upstream of the switching element 10. The monitoring of the voltage at the input 16 by means of the control device 4 thus results in a value above the first voltage limiting value, in particular above a second voltage limiting value G2. When a functional request is present or after a predefinable time has expired, the switching element 14 is actuated by means of the control device 4, as a result of which the load 2 can be switched. If, for example, a voltage which exceeds the second voltage limiting value G2 is present again at the input 16, the load 2 is switched by means of the control device 4 after the vehicle is restarted (=ignition lock in position 0). Depending on the type and design of the control logic for the load 2, other functional requests for switching the load 2 can also be switched as a function of the voltage detected upstream of the switching element 14.

FIG. 2 shows an alternative embodiment of the device 1. Here, one of the voltage supplies 6 or 8, for example the voltage supply 6, a 42V vehicle-mounted electrical system in the vehicle, is provided jointly for the control device 4 and the load 2. The load 2 is switched by the external control device 4. The control device 4 uses the input 16 to monitor the voltage of the supply voltage 6 which is detected upstream of the switching element 14. In the event of a fault in the voltage supply 6, the associated fuse element 10 is triggered. There is thus no voltage applied to the input 16 of the controller or of the control device 6, and the voltage drops below the voltage limiting value G1. The switching element 14 is deactivated. The switching element 14 is embodied, for example, as a relay with a non-energized, open switch.

By replacing the defective fuse with a new fuse element 10, the control element 4 is supplied with voltage from the voltage supply 6. The voltage applied to the input 16 exceeds the voltage limiting value. The switching element 14 is not switched by means of the control device 4 until after a predefined time has expired and a functional request is present, as a result of which the load 2 is connected into the circuit. Thus, the control device 4 is supplied with voltage first, and the load 2 is supplied with voltage after a time has expired. As a result, an arc is reliable avoided.

FIG. 3 shows a further alternative embodiment of the device 1. Here, said device 1 comprises both the control device 4 and the fuse elements 10 and 12 for the voltage supply 6 or 8 of the load 2 or control device 4. The control device 4 detects and monitors, as already described above, the voltage in the branch for supplying the load 2 upstream of the switching element 14. Here, a distinction is made between two faults as follows. If only the voltage in the branch of the supply of the load 2 fails, i.e. the control device 4 continues to be supplied with voltage by means of the supply voltage 8 and the voltage drops below the voltage limiting value at the input 16, the switching element 14 is deactivated by means of the control device 4. Insertion of a new fuse element 10 leads, as represented in the exemplary embodiment in FIG. 1, to activation of the switching element 14, as a result of which the load 2 can be switched in accordance with a function request.

If both voltage supplies 6 and 8 fail, i.e. neither the control device 1 or the load 2 are supplied with voltage, the switching element is actuated only after a predefined time has expired, as represented in the exemplary embodiment in FIG. 2.

1. Device (1) for disconnecting and switching a load (2) with a control device (4), characterized by a switching element (14) which is arranged between a voltage supply (6) and the load (2) and which is connected to the control device (4), and an input (16) for the control device (4), provided between the voltage supply (6) and the switching element (14), for monitoring at least one voltage limiting value, the control device (4) deactivating the switching element (14) when the voltage drops below a first voltage limiting value.

2. Device according to claim 1, characterized in that the control device (4) activates the switching element (14) when the voltage exceeds a second voltage limiting value.

3. Device according to claim 1 or 2, characterized in that a semiconductor element or a relay is provided as the switching element (14).

4. Device according to one of claims 1 to 3, characterized in that the control device (4) and the load (2) are jointly protected by means of a fuse element (10), it being possible to switch the switching element (14) with a delay when the voltage exceeds the second voltage value.
